(19) United States
(12) Patent Application Publication
(10) Pub. No.: US 2026/0050622 A1
(43) Pub. Date: Feb. 19, 2026

(54) SEMANTIC TEXT ZOOM

(71) Applicant: Adobe Inc., San Jose, CA (US)

(72) Inventors: Gabriela Susana Chennisi DUNCOMBE, Houston, TX (US); Mary Youngyin Tsai, Philadelphia, PA (US)

(21) Appl. No.: 18/804,426

(22) Filed: Aug. 14, 2024

(51) Int. Cl. G06F 16/34; G06F 3/04847; G06F 40/166

(52) U.S. Cl. CPC G06F 16/345; G06F 3/04847; G06F 40/166

(57) ABSTRACT

In various examples, semantic text zoom is enabled for a user interface of an application. For example, a document is analyzed to determine a plurality of semantic zoom levels associated with textual information included in the document. Continuing this example, a machine learning model generates a plurality of dynamic abstractive text summarizations corresponding to the plurality of semantic zoom levels. In an embodiment, dynamic abstractive text summarizations are displayed in the user interface based on a selected semantic zoom level.

### BACKGROUND

Various types of artificial intelligence (AI) models can be trained to perform tasks. For example, a model can be trained to generate a transcript of recorded audio and/or video. In addition, these transcripts can contain large amounts of text that can be difficult for users to reach, search, or otherwise parse for information. In general, it can create a difficult user experience to navigate a user interface that includes a large amount of textual information. For example, users may not have time to read long documents or transcripts in their entirety. Furthermore, different users have varying abilities, preferences, and learning styles when it comes to processing information. As a result, there is a need for intuitive and dynamic user interfaces that allow for the processing of large amounts of text.

### SUMMARY

Embodiments described herein are directed to generating a dynamic user experience (UX) and/or user interface (UI) that utilize a machine learning model to generate dynamic abstractive text summarization to provide semantic text zooming capabilities. Advantageously, in various embodiments, the systems and methods described are directed towards applying semantic text zooming to large bodies of text to allow users to zoom in and out of different levels of abstraction of the large bodies of text. In particular, a large language model (LLM) generates various levels of dynamic abstractive text summarization for all or various portions of text. For example, a long, medium, and short semantic abstraction of a transcript are generated and used to provide zoom operations for various portions of the transcript presented within the UI.

The systems and methods described are capable of adding additional semantic zoom capabilities for text in a UI to create an improved user experience that enables more efficient interactions with textual information. For example, a user can “zoom out” (e.g., cause an abstractive summary to be generated that conveys the same meaning, concepts, topics, main ideas etc. while reducing the length of the text) on a body of text, and the UI will be subsequently updated with an dynamic abstractive text summarization of the body of text, allowing the user to quickly scan the text and determine where to focus their attention. In an embodiment, semantic text zoom is used to enable text-based video editing by at least providing dynamic abstractive text summarization of a transcript to allow users to quickly and efficiently find relevant portions of the video.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts a user interface of an application including semantic text zooming, which is provided to a user, in accordance with at least one embodiment.

FIG. 3 depicts a user interface of an application including semantic text zooming, which is provided to a user, in accordance with at least one embodiment.

FIG. 4 depicts a user interface of an application including semantic text zooming, which is provided to a user, in accordance with at least one embodiment.

FIG. 5 depicts an example process flow for generating dynamic abstractive text summarizations, in accordance with at least one embodiment.

FIG. 6 depicts an example process flow for presenting a user interface that includes semantic text zooming to a user, in accordance with at least one embodiment.

FIG. 7 is a block diagram of an exemplary computing environment suitable for use in implementations of the present disclosure.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

Modern application development focuses on the user experience (UX) and attempts to effectively present information and features to users. In one example, conventional implementations of semantic zooming of visual information (e.g., photos) changes what is displayed in a user interface (UI) and how the visual information is presented as the user zooms in or out. Semantic zooming allows users of an application to be presented with data in a way that is relevant to the current level of focus without overwhelming the user with information at ineffective levels of detail. Accordingly, at a zoomed-out level the user is presented with broad, simplified overview of the visual information which provides the user with a clear starting point and an understanding of the overall information available. As the user zooms in, additional details are displayed and at the most zoomed-in level the user has access to detailed visual information, such as individual data points or specific content items.

Generating visual information for semantic zooming requires UX and/or UI engineers to design and develop new visual information at various zoom levels that captures the semantic information of the original visual information. In addition to the skill and effort required to develop the new visual information, the development and generation of this visual information requires additional development time and computing resources. Furthermore, the visual information must be tested as part of the overall UX for an application and these development and testing resources are not generally applicable to other applications. In other words, developing and implementing semantic zooming features for visual information is not only time and resource intensive but is specific to the application and/or visual information for which the semantic zooming features are being developed. Lastly, the traditional techniques for developing and implementing semantic zooming features for visual information are not applicable to textual information. As such, semantic zooming features have been limited to visual information and require additional development time and computing resources to produce and test.

Accordingly, embodiments described herein generally relate to using dynamic abstractive text summarization to perform semantic text zooming to allow users to dynamically view and navigate textual information at various levels of abstraction. In accordance with some aspects, the systems and methods described are directed to using a machine learning model such as a large language model (LLM) to analyze text, determine the structure and content of the text, and generate abstractive text summaries at various levels of abstraction. In various embodiments, the abstractive text summaries are provided to an application to enable the application to provide semantic text zooming capabilities via a user interface (UI) of the application.

In various embodiments, the LLM generates the dynamic abstractive text summarization to include the main concepts and ideas of the original text, but generates new shorter text that conveys the core information associated with the main concepts and/or ideas of the original text determined by the LLM. For example, the LLM determines the structure and content of a textbook and generates dynamic abstractive text summarization at various abstraction levels and/or for various sections of the textbook, such as long, medium, or short, for the entire textbook or portions thereof such as chapters, sections, and/or subsections. In an embodiment, the dynamic abstractive text summarizations are used to provide semantic text zooming for the user interface of the application. For example, at a zoomed-out level the user is presented with a broad and/or simplified overview of the content (e.g., a high level of text abstraction), which allows the user to develop an understanding of the overall information available. Continuing this example, as the user zooms in, the application, via the user interface, displays more detailed semantic information about the user's selection. In one embodiment, the LLM is used to generate dynamic abstractive text summarizations of a transcript for a video editing application, allowing users to quickly find important information via semantic zooming of the dynamic abstractive text summarizations.

Aspects of the technology described herein provide a number of improvements over existing technologies. For instance, the user experience (UX) provided by the improved UI with semantic text zooming allows for easier and more efficient navigation of textual information, as well as improving the user's ability to extract and/or locate relevant and/or important information. In addition, semantic text zooming provides improved performance in various applications. For example, video editing applications can use semantic text zooming to convey additional information to the user to enable the user to more efficiently search for information in a transcript and/or video, allowing for easier editing. For instance, traditional video editing tools are expensive and complex, requiring that the user be trained to use generally complex user interfaces. To become adept, users of video editing must acquire an expert level of knowledge and training to master the processes and user interfaces for typical video editing systems.

Additionally, these video editing tools often rely on selecting video frames or a corresponding time range, which often do not convey relevant information. These video editing tools can be inherently slow and fine-grained, resulting in editing workflows that are often considered tedious, challenging, or even beyond the skill level of many users. In other words, timeline-based video editing that requires selecting video frames or time ranges provides an interaction modality with limited flexibility, limiting the efficiency with which users interact with conventional video editing interfaces. Embodiments of the present disclosure overcome the above, and other problems, by providing mechanisms for semantic text zooming.

Various terms are used throughout this description. Definitions of some terms are included below to provide a clearer understanding of the ideas disclosed herein.

As used herein, a “semantic zoom level” refers to an amount of abstraction of textual information obtained from a document or other data. In accordance with some aspects of the technology described herein, a particular semantic zoom level is associated with a length or amount of textual information included in a dynamic abstractive text summarization generated based on the textual information obtained from the document, the other data, or a portion thereof.

As used herein, a “dynamic abstractive text summarization” refers to a text summarization abstracted from textual information obtained from a document or other data. In accordance with some aspects of the technology described herein, a machine learning model (e.g., a large language model) abstracts textual information at one or more semantic zoom levels to generate the dynamic abstractive text summarizations that maintain semantic information from the textual information.

As used herein, a “semantic zoom operation” refers to an operation by an application to replace textual information or a portion thereof displayed in a user interface with a dynamic abstractive text summarization corresponding to the textual information. In accordance with some aspects of the technology described herein, an application performs a semantic zoom operation, in response to an input from a user, by at least modifying a display to present the dynamic abstractive text summarization.

As used herein, a “document” refers to a data object that includes textual information that can be processed by a machine learning model. A document comprises any data or reference to data that can be obtained and displayed in an application.

As used herein, a “transcript” refers to a data object that includes textual information converted and/or extracted from audio data. A transcript comprises any data or reference to data that is obtained from audio and/or video data by an application or user.

As used herein, a “semantic zoom tool” refers to a system that generates dynamic abstractive text summarizations based on a set of semantic zoom levels and textual information. In accordance with some aspects of the technology described herein, the semantic zoom tool causes a machine learning model (e.g., a large language model) to generate abstractive text summarizations of textual information obtained by the semantic zoom tool.

As used herein, a “semantic zoom bar” refers to a user interface element that allows a user to select a sematic zoom level associated with textual information displayed in a user interface of an application. In accordance with some aspects of the technology described herein, the semantic zoom bar is displayed in the user interface of the application and, as a result of being interacted with by the user, causes the application to modify the user interface to include a dynamic abstractive text summarization.

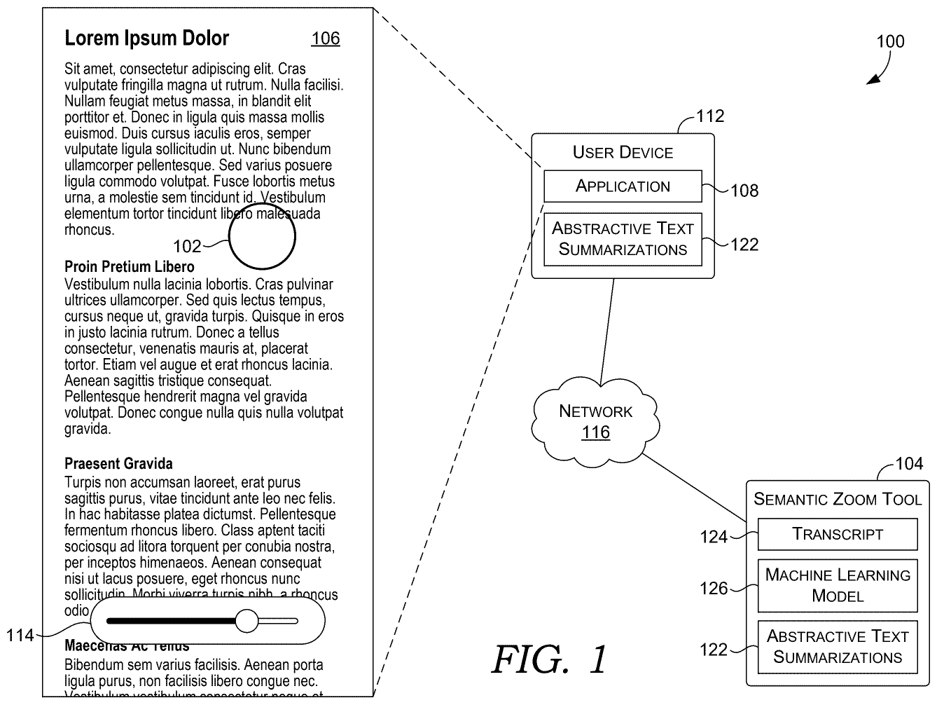

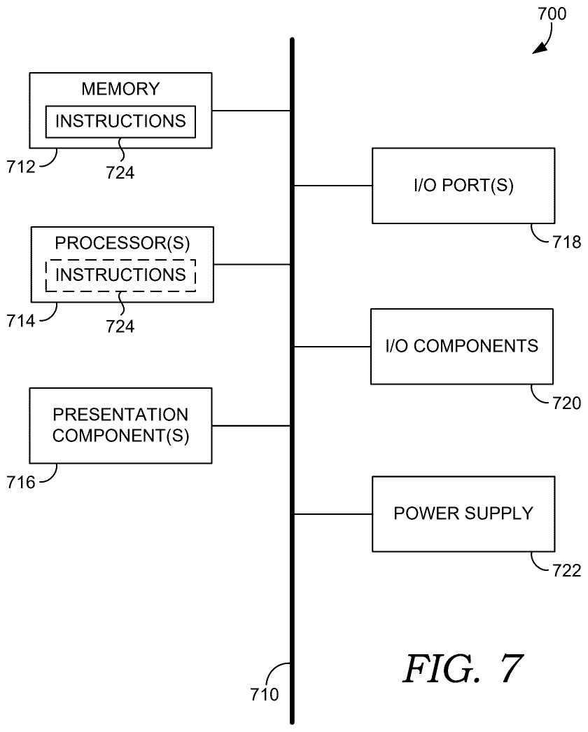

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 7.

It should be understood that operating environment 100 shown in FIG. 1 is an example of one suitable operating environment. Among other components not shown, operating environment 100 includes a user device 112, semantic zoom tool 104, and a network 116. Each of the components shown in FIG. 1 can be implemented via any type of computing device, such as one or more computing devices 700 described in connection with FIG. 7, for example. These components can communicate with each other via network 116, which can be wired, wireless, or both. The network 116 can include multiple networks, or a network of networks, but is shown in simple form so as not to obscure aspects of the present disclosure. By way of example, the network 116 can include one or more wide area networks (WANs), one or more local area networks (LANs), one or more public networks such as the Internet, and/or one or more private networks. Where the network 116 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, the network 116 is not described in significant detail.

It should be understood that any number of devices, servers, and other components can be employed within operating environment 100 within the scope of the present disclosure. Each can comprise a single device or multiple devices cooperating in a distributed environment. For example, the semantic zoom tool 104 includes multiple server computer systems cooperating in a distributed environment to perform the operations described in the present disclosure. In one embodiment, the semantic zoom tool 104 is provided as a service of a computing resource service provider and provided to the user device over the network 116.

User device 112 can be any type of computing device capable of being operated by an entity (e.g., individual or organization) and obtains data from the semantic zoom tool 104 and/or a datastore which can be facilitated by the semantic zoom tool 104 (e.g., a server operating as a front end for the datastore). The user device 112, in various embodiments, executes an application 108 that has access to or otherwise maintains dynamic abstractive text summarizations 122 of textual information and/or visual information. For example, the application 108 includes a video editing application to enable script editing, video editing, real-time previews, playback, and video presentations including visualizations and/or video effects, such as a standalone application, a mobile application, a web application, and/or the like.

In various embodiments, to enable these operations the application 108 includes a semantic zoom bar 114 and a cursor 102. For example, the semantic zoom bar 114 allows the user via a presentation interface 106 of the application 108 to select a semantic zoom level (e.g., an amount of abstraction of the text) of textual or other information displayed in the presentation interface 106. In various embodiments, the cursor 102 allows the user to navigate the presentation interface 106 and select the semantic zoom level using the semantic zoom bar 114. For example, the user can select the semantic zoom level using the semantic zoom bar 114 using the cursor 102, then select a portion of the text using the cursor 102 and can change the semantic zoom level associated with the selected portion of the text. Other methods of interacting with the presentation interface 106, for example, are used to interact with the textual or other information displayed in the presentation interface 106 and select the semantic zoom level. In an embodiment, a pinch to zoom method is used by a user to select the semantic zoom level. In addition, other types of gestural affordances can be used to interact with or otherwise select the semantic zoom level in accordance with various embodiments.

In some implementations, user device 112 is the type of computing device described in connection with FIG. 7. By way of example and not limitation, the user device 112 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 112 can include one or more processors, and one or more computer-readable media. The computer-readable media can also include computer-readable instructions executable by the one or more processors. In an embodiment, the instructions are embodied by one or more applications, such as the application 108 shown in FIG. 1. The application 108 is referred to as a single application for simplicity, but its functionality can be embodied by one or more applications in practice.

In various embodiments, the application 108 includes any application capable of facilitating the exchange of information between the user device 112 and the semantic zoom tool 104. For example, the application 108 obtains a transcript 124 of audio stream corresponding to a video stream from a transcription tool (e.g., a service of the computing resource service provider) and provides the transcript 124 to the semantic zoom tool 104 and obtains, in response, the dynamic abstractive text summarizations 122. In various embodiments, the transcripts are generated manually via a human listener transcribing recorded audio and/or video.

In yet other examples, the application 108 includes a web browser, digital reader, or other application that displays textual information to a user. In some implementations, the application 108 comprises a web application, which can run in a web browser, and can be hosted at least partially on the server-side of the operating environment 100. In addition, or instead, the application 108 can comprise a dedicated application, such as an application being supported by the user device 112, and the semantic zoom tool 104. In some cases, the application 108 is integrated into the operating system (e.g., as a service). It is therefore contemplated herein that “application” be interpreted broadly. Some example applications include ADOBE® PREMIERE, a cloud-based video editing application, and ADOBE ACROBAT®, which allows users to view, create, manipulate, print, and manage documents.

For cloud-based implementations, for example, the application 108 is utilized to interface with the functionality implemented by the semantic zoom tool 104. In some embodiments, the components, or portions thereof, of the semantic zoom tool 104 are implemented on the user device 112 or other systems or devices. Thus, it should be appreciated that the semantic zoom tool 104, in some embodiments, is provided via multiple devices arranged in a distributed environment that collectively provide the functionality described herein. Additionally, other components not shown can also be included within the distributed environment.

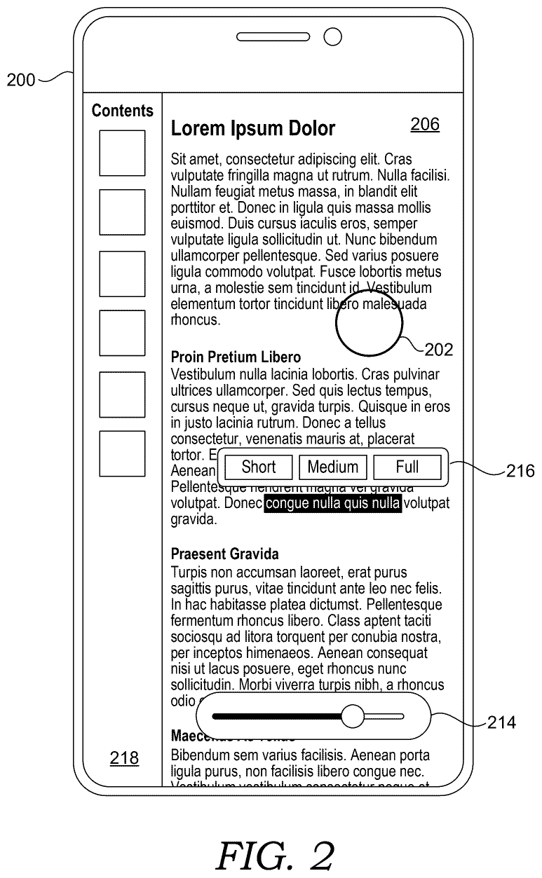

As illustrated in FIG. 1, the application 108 provides a user experience that enables more efficient interaction with text displayed in the presentation interface 106 using the dynamic abstractive text summarizations 122 generated by a machine learning model of the semantic zoom tool 104. In various embodiments, the dynamic abstractive text summarizations 122 enable semantic zoom operations for an entire document (e.g., the transcript 124, an article, book, publication, or other textual information) or a section of the document. Furthermore, the machine learning model 126, in an embodiment, generates the dynamic abstractive text summarizations 122 prior to a user interacting with the document via the presentation interface 106 of the application. In other embodiments, the dynamic abstractive text summarizations 122 are generated as the user interacts with the textual information displayed in the presentation interface 106. In one example, the application 108 is a web browser, and the semantic zoom tool 104 and/or the machine learning model generates the dynamic abstractive text summarizations 122 as the user navigates the webpage displayed by the application 108. In various embodiments, the dynamic abstractive text summarizations 122 are dynamically modified and/or replaced within the presentation interface 106 in response to inputs from the user. In one example, the dynamic abstractive text summarizations 122 (at different semantic zoom levels) are generated by the semantic zoom tool 104, stored by the application 108, and dynamically switched between in the presentation interface 106. In another example, a particular dynamic abstractive text summarization is generated in response to a user selecting a portion of text within the presentation interface 106 and selecting a semantic zoom level (e.g., using a contextual user interface element as described below in connection with FIG. 2).

In various embodiments, the user can select, using the cursor 102, a region or selection of text in the presentation interface 106, at which time the semantic zoom bar 114 appears as a contextual user interface element, allowing the user to select the semantic zoom level for the select portion of the text. For example, selection of text and a corresponding semantic zoom level causes the application 108 to update the presentation interface 106 to replace the selected portion of text with the dynamic abstractive text summarizations 122 associated with the selected portion of text. Continuing this example, if the user selects a “medium” semantic zoom level, the selected portion of text is replaced with a dynamic abstractive text summarization at a medium abstraction level.

In various embodiments, the semantic zoom levels are determined based on concepts and/or ideas in the document and are not tied to the length of the document. For example, a first semantic zoom level is associated with a first concept such as “dogs,” and a second semantic zoom level is associated with a second concept such as “cats.” As a result, the abstractive text summary associated with the first semantic zoom level summarizes the discussion in the document of “dogs” (e.g., dog training, dog nutrition, dog breeds, etc.), and the abstractive text summary associated with the second semantic zoom level summarizes the discussion in the document of “cats.” Various combinations of semantic zoom levels can be used in combinations—for example, a semantic zoom level associated with a length of the summary provided can be used in combination with a semantic zoom level associated with topics described in the document (e.g., transcript 124).

In an embodiment, the machine learning model 126 determines a plurality of semantic zoom levels. For example, the machine learning model 126 determines the plurality of semantic zoom levels based on various factors such as document length, document structure, user preferences, document complexity, number of speakers identified in the document, or metadata associated with the document. In some embodiments, a separate machine learning model is used to determine the plurality of semantic zoom levels. For example, the separate machine learning model analyzes the document and generates information associated with the document that is used to determine the plurality of semantic zoom levels. Continuing this example, the separate machine learning model can generate and/or condition a prompt for the machine learning model 126 to cause the machine learning model 126 to generate the dynamic abstractive text summarizations corresponding to the plurality of semantic zoom levels.

In an embodiment, the plurality of semantic zoom levels are determined based on a length of the document. For example, proportional levels of zoom corresponding to a reduction in the length of the document and/or section of the document are used to generate the plurality of semantic zoom levels. Continuing this example, if five levels of semantic zoom are desired, each semantic zoom level could represent a one-fifth increase or decrease in the length of the textual information. In various embodiments, proportional levels of zoom are exponential and not linear.

In various embodiments, a plurality of semantic zoom levels and the contents of the document are used to generate a prompt to the machine learning model 126. For example, the machine learning model 126 includes any number of machine learning models or technologies, such as a large language model (LLM) with natural language processing (NLP) capabilities including determined context, semantics, and language generation in order to generate dynamic abstractive text summarizations that can include paraphrasing, rephrasing, or otherwise generating new text (e.g., sentences and paragraphs) not included in the original text (e.g., the transcript 124). In some embodiments, the machine learning model 126 may include, or access, an LLM that takes, as input, a prompt (e.g., natural language text defining the plurality of semantic zoom levels), and provides, as output, the dynamic abstractive text summarizations 122. For example, a language model is a statistical and probabilistic tool that determines the probability of a given sequence of words occurring in a sentence (e.g., via next sentence prediction [NSP] or multilingual large language model [MLM]). In various embodiments, the machine learning model 126 is a tool that is trained to predict the next word in a sentence. In one example, the machine learning model 126 is an LLM trained on an enormous amount of data. Some examples of LLMs are an Open Pre-trained Transformer Language Model (OPT), Bidirectional and Auto-Regressive Transformers (BART), Bidirectional Encoder Representations from Transformers (BERT), and Generative Pre-trained Transformer (GPT) 2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision.

Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities in order to determine the plurality of semantic zoom levels and generate the dynamic abstractive text summarizations 122. As described, in some embodiments, the machine learning model 126 takes on the form of an LLM, but various other machine learning models can additionally or alternatively be used. For example, a first machine learning model can be used to determine a structure of the document (e.g., transcript 124), and a second machine learning model can be used to generate a prompt to be provided as an input to the machine learning model 126 to cause the machine learning model 126 to generate the dynamic abstractive text summarizations.

In embodiments, the machine learning model 126 is fine-tuned. In one example, fine-tuning refers to the process of retraining a pre-trained model on a new dataset without training from scratch. In an embodiment, fine-tuning takes weights of a trained model and uses those weights as the initialization value, which is then adjusted during fine-tuning based on the new dataset. For example, fine-tuning can be used in cases in which a specific dataset exists that can be used to fine-tune the model for a particular task, user case, and/or environment, such as a dataset comprising transcripts or another particular type of documents that the machine learning model 126 is going to be provided as an input (e.g., generating dynamic abstractive text summarization of the particular type of document). In some implementations, the LLM is fine-tuned on various video transcripts to leverage its text generation ability in association with generating dynamic abstractive text summarizations 122 for the transcript 124.

The dynamic abstractive text summarizations 122 generated by the machine learning model, in various embodiments, take on any number of forms. As one example, the dynamic abstractive text summarizations 122 include text that summarizes concepts, ideas, questions, and answers discussed during a video associated with the transcript 124. As another example, the dynamic abstractive text summarizations 122 include a storyline described in text or other documents including abstractive summaries of different sections of the text or other documents (e.g., chapters, acts, etc.). Continuing this example, if a story in the text is written in three acts, the machine learning model 126 can generate an abstractive text summary for each act, even if the story has no demarcation between the acts (e.g., headings, chapters, different fonts, etc.).

In an embodiment, the machine learning model 126 generates a long, medium, and short dynamic abstractive text summarizations 122 for the transcript 124 of other documents and/or portions thereof. For example, the long abstractive text summary retains the semantic meaning of the transcript while reducing the amount of text by a first amount; the medium abstractive text summary retains the semantic meaning of the transcript 124 while reducing the amount of text by a second amount that is more than the first amount; and the short abstractive text summary retains the semantic meaning of the transcript 124 while reducing the amount of text by a third amount that is greater than the second amount. As can be appreciated, an abstractive text summary generated for one document or in association with one prompt, for example, will have a different set of sentences from an abstractive text summary generated for another document, portion of the same document, or another prompt.

FIG. 2 illustrates a user interface 200 of an application including a presentation interface 206, which is provided to a user, in accordance with embodiments of the present disclosure. FIGS. 2-4 depict user interfaces 200-400 that are generated by an application, such as the application 108, as described above in connection with FIG. 1. For example, the user can interact with text and perform various operations described in the present disclosure, such as generating abstractive text summaries, which are provided to the user via the user interface 200. Continuing this example, the user can then initiate the presentation interface 206 in order to interact with the textual information presented in the user interface 200. In some embodiments, the user interfaces 200-400 are generated at least in part by other applications. In addition, in some embodiments, data or other information displayed in the user interfaces 200-400 are obtained from other applications and/or devices including remote applications, services, and devices. For example, the dynamic abstractive text summarizations are obtained from the machine learning model 126 of the semantic zoom tool 104 described in connection with FIG. 1. Furthermore, in various embodiments, additional panels or graphical user interface elements are included in the user interfaces 200-400 to provide users with additional functionality.

In an embodiment, the user interface 200 includes a semantic zoom bar 214, a cursor 102, a contextual element 216, and a bookmarks tab 218. In various embodiments, the semantic zoom bar 214 allows the user via a presentation interface 206 to select a semantic zoom level (e.g., an amount of abstraction of the text) of textual or other information displayed in the presentation interface 206. For example, the semantic zoom bar 114 can apply a particular semantic zoom level to the entire document (e.g., the textual or other information displayed in the presentation interface 206). Furthermore, in various embodiments, the user, via the cursor 202, selects a portion of text displayed in the presentation interface 206, which causes the application to display the contextual element 216. For example, the contextual element 216 can display various operations that the user can perform based on the context of the selected text.

In an embodiment, the various operations include generating an abstractive text summary at various semantic zoom levels (e.g., long, medium, or short). Continuing this example, once the user selects an operation displayed in the contextual element 216, the application replaces the text displayed in the presentation interface 206 with the abstractive text summary associated with the selected text. Furthermore, in various embodiments, the presentation interface 206 includes the bookmarks tab 218, which allows the user to navigate the document and/or textual information displayed as well as interact directly with sections of the document to generate or otherwise display abstractive text summaries. In various embodiments, the abstractive text summaries are generated prior to the user interacting with the document via the presentation interface 206 and are stored in memory of the application. In other embodiments, the abstractive text summaries are generated in response to user input to the user interface of the application.

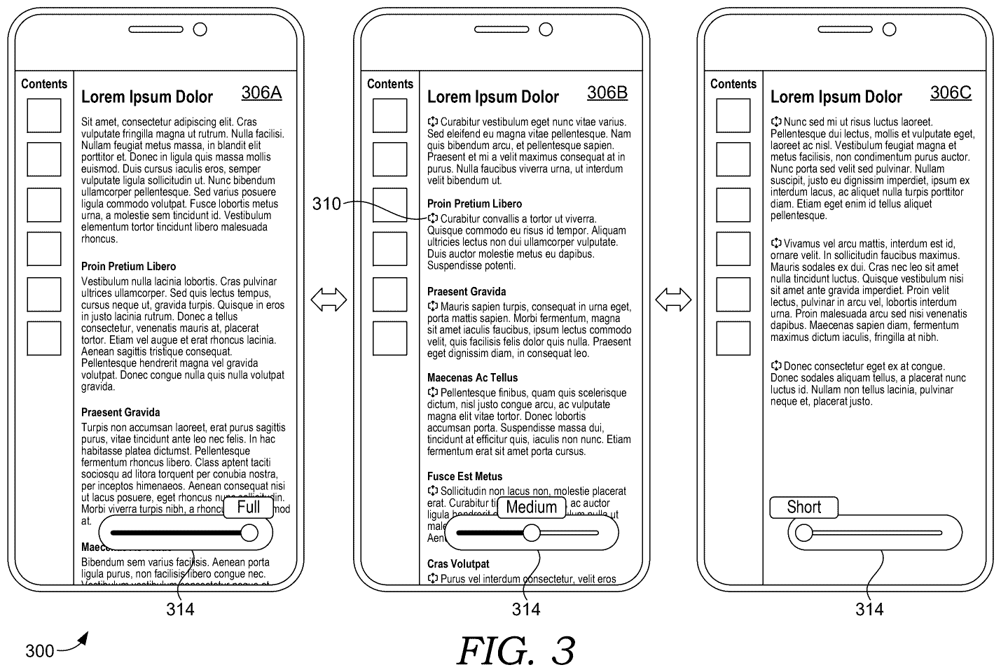

FIG. 3 illustrates a user interface 300 of an application in various states including a set of presentation interfaces 306A-306C which are provided to a user in response to a set of inputs, in accordance with embodiments of the present disclosure. In various embodiments, the user interface 300 is a component of the application 108 process, as described in FIG. 1. For example, the user can interact with text and perform various operations described in the present disclosure, such as generating abstractive text summaries for one or more sections of a document at a plurality of semantic zoom levels, which are provided to the user via the user interface 300.

In an embodiment, the user can initiate the presentation interface 306A in order to interact with the textual information presented in the user interface 300. Continuing the example, as a result of the user providing an input via a semantic zoom bar 314, the application modifies or otherwise causes an update to the presentation interface 306B to display abstractive text summaries corresponding to the selected semantic zoom level. In an embodiment, the user interface 300 includes the semantic zoom bar 314 and a user interface element 310.

As illustrated in FIG. 3, in various embodiments, each of the presentation interfaces 306A-306C correspond to a different semantic zoom level. In the example illustrated, the presentation interface 306A corresponds to a “full” semantic zoom level (e.g., the original text without an abstractive summarization), the presentation interface 306b corresponds to a “medium” semantic zoom level (e.g., abstractive summarization of the original text that reduces the amount of textual information by an amount), and the presentation interface 306C corresponds to a “short” semantic zoom level (e.g., abstractive summarization of the original text that reduces the amount of textual information more than the “medium” semantic zoom level). Furthermore, in various embodiments, the abstractive text summaries and/or presentation interface modifies the structure of the textual information displayed.

In the example illustrated in FIG. 3, the “short” semantic zoom level removes the headings from the text and summarizes the document as a whole. In various embodiments, the machine learning model generating the abstractive text summaries modifies the structure of the document at different semantic zoom levels. For example, the machine learning model generates an abstractive summary that combines the concepts described in two or more sections of the document.

Furthermore, in various embodiments, the user interface element 310 allows the user to expand a particular abstractive summary to obtain additional information. For example, selection of the user interface element 310 causes the associated abstractive summary to be reverted to the original text. In another example, selection of the user interface element 310 causes the associated abstractive summary to be increased one or more semantic zoom levels to provide additional details and/or explanation. In this manner the user can quickly navigate and comprehend large amounts of textual information (e.g., by reviewing a short, high-level summary), and then zoom in on particular sections and/or information by expanding or otherwise modifying the semantic zoom level associated with a desired section of the text in accordance with at least one embodiment.

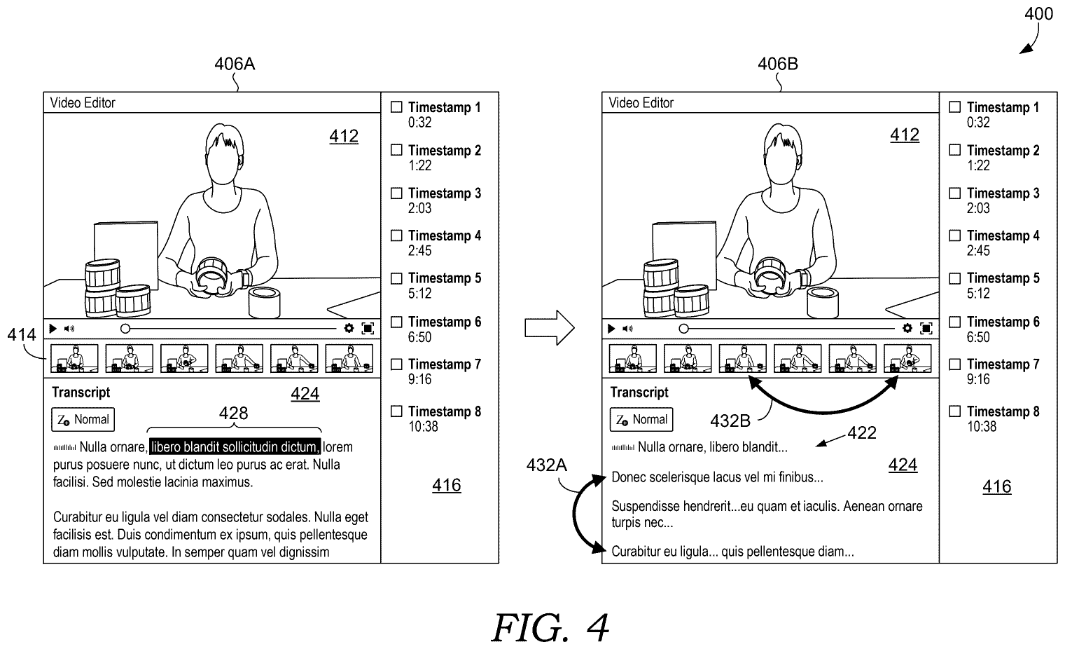

FIG. 4 illustrates a user interface 400 of an application including presentation interfaces 406A and 406B, which is provided to a user, in accordance with embodiments of the present disclosure. In various embodiments, the user interface 400 is of the application 108, as described in FIG. 1. For example, the user can edit a video using the user interface 400 including a transcript panel 424, a timeline 414, timestamps panel 416, and a video playback region 412. Furthermore, in various embodiments, a user can interact with the transcript panel 424 to edit the video. For example, the user can move a text segment 428 associated with frames in the timeline 414 to move the corresponding frames of the video. In the example illustrated in FIG. 4, editing the video via text segments is shown with an arrow 432A demonstrating the user moving (e.g., drag and dropping the text segment 428 using a cursor) and an arrow 432B demonstrating movement of the video frames corresponding to the selected text segments. In various embodiments, the arrows 432A and arrow 432B are not presented to the user in the presentation interface 406B but are shown in FIG. 4 for purposes of illustrating various video editing operations.

In an embodiment, the transcript panel 424 presents a portion of a script and/or transcript extracted from the video. Furthermore, the transcript panel 424 provides an interface to allow the user to select the text segment 428. For example, as a result of the user selecting the text segment 428, an abstractive text summary is generated and/or otherwise displayed for the text segment 428. In some embodiments, the presentation interface 406A is updated to generate the presentation interface 406A and display an dynamic abstractive text summarization 422 in the transcript panel 424. For example, the text segment 428 is replaced in the transcript panel 424 with the dynamic abstractive text summarization 422.

In the example illustrated in FIG. 4, portions of the transcript (e.g., lines of dialogue) displayed in the transcript panel 424 are associated with particular timestamps in the timestamps panel 416 (e.g., indicating a time in the video associated with a portion of the transcript). In addition, in various embodiments, the dynamic abstractive text summarization 422 is associated with a plurality of timestamps in the timestamps panel 416. For example, the dynamic abstractive text summarization 422 is associated with a plurality of timestamps representing an interval of the transcript and corresponding timeline of the video summarized in the dynamic abstractive text summarization 422.

As mentioned above, in some embodiments the transcript panel 424 allows the user to navigate a transcript by at least zooming in and out of portions of the transcript by at least generating the text summarization 422. For example, the user can generate the dynamic abstractive text summarization 422 for a particular speaker in the video and/or transcript. In another example, the user can generate the dynamic abstractive text summarization 422 for a portion of the video using the timestamps in the timestamps panel 416 (e.g., generate the dynamic abstractive text summarization 422 for a particular interval of time within the video).

In various embodiments, the frames displayed in the timeline 414 can be provided as an input to the machine learning model 126, as described above in connection with FIG. 1, and the dynamic abstractive text summarization 422 can include or otherwise comprise visual information included in the frames. For example, an LLM can take, as an input, the images and the videos in addition to or as an alternative to text included in the transcript. Continuing this example, the LLM can generate dynamic abstractive text summarizations of the video and/or image data and provide a natural language explanation of the video (e.g., what is occurring or being depicted).

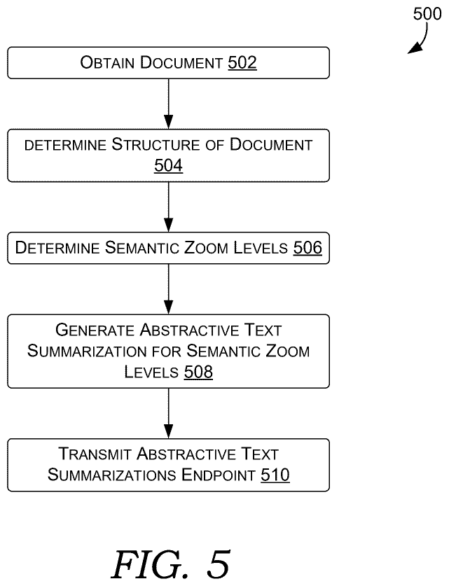

FIG. 5 is a flow diagram showing a method 500 for generating dynamic abstractive text summarizations to use for semantic text zoom within a user interface of an application in accordance with at least one embodiment. The method 500 can be performed, for instance, by the semantic zoom tool 104 of FIG. 1. Each block of the methods 500 and 600 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, the system implementing the method 500 obtains a document. As described above in connection with FIG. 1, in various embodiments, the document can include various types of textual information such as books, articles, transcripts, or any other structure or unstructured document. For example, the application provides the textual information displayed in a user interface. In another example, the document is provided to the semantic zoom tool prior to being displayed by the application.

At block 504, the system implementing the method 500 determines the structure of the document. For example, a machine learning model extracts information from the document and/or metadata associated with the document. In an embodiment, the structure of the document includes speakers in a transcript, headings, subheadings, chapters, subchapters, or any other demarcation between sections of the document. In various embodiments, if an identity of a speaker in audio or video data is unknown, other methods of differentiating speakers can be user such as assigning identification information to the speaker such as “speaker one,” “speaker two,” etc. At block 506 the system implementing the method 500 determines a set of semantic zoom levels associated with the document. For example, the set of semantic zoom levels correspond to the structure of the document determined at block 504. In other examples, the semantic zoom levels are determined based on the length of the document. In yet other examples, the semantic zoom levels are determined based on the concepts and ideas described in the document. Furthermore, in various embodiments, some or all of the semantic zoom levels described above can be used in combination. For example, semantic zoom levels (e.g., short, medium, and long) based on the length of the document can be used in combination with semantic zoom levels based on speakers or chapters of the document.

At block 508, the system implementing the method 500 generates dynamic abstractive text summarizations for the semantic zoom levels. For example, a machine learning model can take as an input the document and the semantic zoom levels and generate the dynamic abstractive text summarizations. In an embodiment, a prompt is generated indicating the semantic zoom levels. Continuing this example, the prompt then is provided to the machine learning model to cause the machine learning model to generate the dynamic abstractive text summarizations. At block 510, the system implementing the method 500 transmits the dynamic abstractive text summarization to an endpoint. For example, the dynamic abstractive text summarizations are transmitted to the application. In another example, the dynamic abstractive text summarizations are transmitted to a computing resource service provider for storage (e.g., to be stored until requested by an application and/or user).

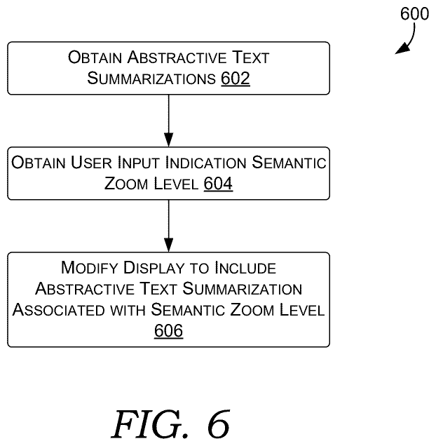

FIG. 6 is a flow diagram showing a method 600 for displaying dynamic abstractive text summarizations in order to provide semantic text zoom capabilities in a user interface of an application in accordance with at least one embodiment. At block 602, the system implementing the method 600 obtains the dynamic abstractive text summarization. For example, the application can obtain the dynamic abstractive text summarization from a datastore of a computing resource service provider. In other examples, the application obtains the dynamic abstractive text summarization from the machine learning model 126 of the semantic zoom tool 104 described in connection with FIG. 1.

At block 604, the system implementing the method 600 obtains user input indicating semantic zoom level. For example, the user, via a user interface element such as a semantic zoom bar or contextual user interface element, indicates a semantic zoom level for a document or portion of the document. At block 606, the system implementing the method 600 modifies the display (e.g., the user interface) to include the dynamic abstractive text summarization associated with the semantic zoom level. For example, the application replaces the document displayed with the dynamic abstractive text summarization corresponding to the selected semantic zoom level.

Having described embodiments of the present disclosure, FIG. 7 provides an example of a computing device in which embodiments of the present disclosure may be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 7 and reference to “computing device.”Computing device 700 typically includes a variety of computer-readable media. Computer-readable media can be any available media that can be accessed by computing device 700 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or non-volatile memory. As depicted, memory 712 includes instructions 724. Instructions 724, when executed by processor(s) 714, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built-in. Illustrative components include a microphone, joystick, game pad, satellite dish, scanner, printer, wireless device, etc. I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 may be equipped with depth cameras, such as stereoscopic camera systems, infrared camera systems, RGB camera systems, and combinations of these, for gesture detection and recognition. Additionally, computing device 700 may be equipped with accelerometers or gyroscopes that enable detection of motion. The output of the accelerometers or gyroscopes may be provided to the display of computing device 700 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A method comprising:
obtaining, by a semantic zoom tool, a document;
determining, by the semantic zoom tool, a plurality of semantic zoom levels for displaying dynamic abstractive text summarizations of the document in a semantic zoom operation of an application, the plurality of semantic zoom levels including at least a first semantic zoom level and a second semantic zoom level, where the second semantic zoom level corresponds to an amount of textual information that is less than the first semantic zoom level;
causing, via the semantic zoom tool, a machine learning model to generate a first dynamic abstractive text summarization corresponding to the first semantic zoom level and a second dynamic abstractive text summarization corresponding to the second semantic zoom level; and
providing, by the semantic zoom tool to the application, the first dynamic abstractive text summarization and the second dynamic abstractive text summarization to allow the application to replace at least a portion of the document with the first dynamic abstractive text summarization or the second dynamic abstractive text summarization in response to obtaining a user input associated with the first semantic zoom level or the second semantic zoom level.

2. The method of claim 1, wherein the plurality of semantic zoom levels are determined based on a structure of the document.

3. The method of claim 2, wherein the structure of the document corresponds to a set of speakers identified in the document.

4. The method of claim 1, wherein the application is a video editing application and the document is a transcript extracted from a video.

5. The method of claim 1, wherein the second dynamic abstractive text summarization includes less text than the first dynamic abstractive text summarization.

6. The method of claim 1, wherein the method further comprises:
obtaining a selection of text from the document and an indication of the first semantic zoom level; and
causing the machine learning model to generate a third dynamic abstractive text summarization of the selection of text corresponding to the first semantic zoom level.

7. The method of claim 1, wherein the plurality of semantic zoom levels include at least a long, medium, and short semantic zoom level.

8. A non-transitory computer-readable medium storing executable instructions embodied thereon that, when executed by a processing device, cause the processing device to perform operations comprising:
causing a user interface of an application to display a document including textual information;
obtaining, via a user interface element, a selection of a first semantic zoom level of a plurality of semantic zoom levels;
causing a machine learning model to generate a dynamic abstractive text summarization at the first semantic zoom level of the document, where the dynamic abstractive text summarization includes less text than the textual information; and
modifying the user interface of the application to display the dynamic
abstractive text summarization.

9. The medium of claim 8, wherein modifying the user interface of the application to display the dynamic abstractive text summarization further comprises replacing a portion of the document with the dynamic abstractive text summarization.

10. The medium of claim 8, wherein causing the machine learning model to generate the dynamic abstractive text summarization is performed prior to the application obtaining the document.

11. The medium of claim 10, wherein the operations further comprise causing the machine learning model to generate a plurality of dynamic abstractive text summarizations associated with the plurality of semantic zoom levels.

12. The medium of claim 8, wherein the user interface element includes a contextual user interface element that is displayed in the user interface in response to a user selecting, via a cursor, a portion of the document.

13. The medium of claim 8, wherein the user interface element includes a semantic zoom bar that allows a user to select the first semantic zoom level of the plurality of semantic zoom levels to be applied to the document.

14. The medium of claim 8, wherein the machine learning model is a large language model.

15. The medium of claim 8, wherein the operations further comprise:
obtaining, via a second user interface element, a second selection of a second semantic zoom level of the plurality of semantic zoom levels; and
modifying the user interface of the application to display a second dynamic abstractive text summarization of at least a portion of the document, where the second dynamic abstractive text summarization corresponds to the second semantic zoom level.

16. A system comprising:
a memory component; and
a processing device coupled to the memory component, the processing device to perform operations comprising:
obtaining a document from an application;
determining a plurality of semantic zoom levels associated with the document;
causing a machine learning model to generate a plurality of dynamic abstractive text summarizations corresponding to the document at the plurality of semantic zoom levels; and
providing the plurality of dynamic abstractive text summarizations to the application.

17. The system of claim 16, wherein the application includes a user interface that enables a user to select a portion of the document and cause the user interface to modify a display of the document to include an dynamic abstractive text summarization of the portion of the document corresponding to a semantic zoom level selected by the user.

18. The system of claim 16, wherein determining the plurality of semantic zoom levels further comprises determining a set of speakers associated with the document based on metadata associated with the document.

19. The system of claim 16, wherein determining the plurality of semantic zoom levels further comprises determining a structure of the document based on at least one of: chapters, headings, and sections included in the document.

20. The system of claim 16, wherein determining the plurality of semantic zoom levels further comprises determining a first semantic zoom level based on a proportion of a length of the document and a second semantic zoom level based on the proportion of the length of the document, where the second semantic zoom level causes the machine learning model to generate a first dynamic abstractive text summarization that is shorter than a second dynamic abstractive text summarization generated based on the first semantic zoom level.
